(19) United States
(12) Patent Application Publication
(10) Pub. No.: US 2009/0094899 A1
(43) Pub. Date: Apr. 16, 2009

(54) Linear Weatherstripping and Dust Plugs Having Multidirectional Flexibility

(76) Inventors: David Loughney, Phelps, NY (US); Bruce A. Rice, Clifton Springs, NY (US)

Correspondence Address: Kenneth J Lukacher;South Winton Court, 3136 Winton Road South, Suite 301, Rochester, NY, 14623, US

(21) Appl. No.: 12/227,093

(22) PCT Filed: May 17, 2007
(86) PCT No.: PCT/US2007/011807

§ 371 Date: Nov. 7, 2008

Related U.S. Application Data
(60) Provisional application No. 60/801,138, filed on May 17, 2006.

(51) Int. Cl. E06B 7/18

(52) U.S. Cl. 49/480.1; 49/506

(57) ABSTRACT

Linear weatherstrips and dust plugs (20, 30, 51, 75) having a plurality of such weatherstrips (10-12, 31-35, 40-42, 60-62) in side-by-side relationship are provided with multidirectional flexibility so as to be useful in corners of window frames and doorways by the use of backing strips (16-18) which are made of lineal strings (19) of thermoplastic material which are criss-crossed to provide intersections and bonded at the intersection to provide an embossed surface. The piles (13-15) are attached to one side of the backing strips (16-18) leaving areas between the piles and the edges of the backing strips (16-18) in assemblies of the weatherstrips on a carrier (22) with the backing strips in edgewise-adjacent relationship. This relationship may be provided by the edges of the backing strips being in contact with each other. Alternatively, the areas of the backing strips of adjacent weatherstrips, between the edges and the piles, may be in overlapping relationship. The carrier (22) is bonded ultrasonically to the backing strips in their adjacent or overlapping areas. When the backing strips are overlapping, the carrier (22) may be eliminated.

This application claims the benefit of priority to U.S. Provisional Application No. 60/801,138, filed May 17, 2006.

The present invention relates to weatherstrips and dust plugs which are provided by assemblies of such weatherstrips. The present invention provides linear weatherstrips and dust plugs which have multidirectional flexibility. The term weatherstrips should be taken generally to include strip brushes and where the terms weatherstrips or weatherstripping appears herein, except as regards the references to the patents and publications cited, should be taken to include strip brushes having applications not limited to where weatherstripping for seals or insulation.

Heretofore, as exemplified by weatherstrips as shown in U.S. Pat. Nos. 4,148,953 and 4,302,494, issued April 1979 and November 1981, respectively, to Robert C. Horton, and also in U.S. Pat. No. 5,807,451, issued September 1998, and U.S. Pat. No. 5,817,390, issued October 1998 to Larry Johnson, pile weatherstripping has been made by ultrasonically attaching piles to backing strips of solid thermoplastic material, such as polypropylene. In International Application No. PCT/US03/32763, and which is available in International Publication No. WO2004/03598, published Apr. 29, 2004, textile woven backings for pile weatherstripping are described. Dust plugs and their applications which utilize conventional weatherstripping having solid thermoplastic backing strips are described in International Application Nos. PCT/US04/12558 (International Publication No. WO2004/096543, Published Nov. 11, 2004) and PCT/US04/038796 (international Publication No. WO/2006/036167, Published Apr. 4, 2006); Multiple conventional weatherstrips on carriers have also been used in sliding window guides, and are shown in U.S. Pat. No. 6,024,815, issued Feb. 15, 2000 to Edward W. Norton.

Multidirectional flexibility is desirable for many applications of weatherstripping and dust plugs. However, since products should be sufficiently strong to be useful in practice, especially so far as tear strength and compressibility are concerned. Weatherstrips having textile backings, while more flexible than those with solid material backings, have been found undesirable for many applications.

It is a principal feature of the present invention to provide weatherstripping and dust plugs incorporating a plurality of weatherstrips which may be produced as linear weatherstrips and dust plugs but which have multidirectional flexibility so as to be fittable and used in corners of window frames, doorways, and other curved frames, especially for fenestration products.

It is another feature of the present invention to provide weatherstrips and dust plugs which are not only flexible, but have sufficient strength so as to stand up and be reliable in sealing against air and water infiltration.

The general feature of this invention therefore is to provide improved pile weatherstripping products which are flexible and which have enhanced strength, especially in ultrasonically welded interfaces between separate parts of the product, such as between backings, piles and backings and support members.

It is a still further feature of the present invention to provide dust plugs which may be produced with material of lower cost, at higher production speeds and with reduced production cost than has been the case with dust plugs heretofore available.

Briefly described, linear weatherstripping with multidirectional flexibility in accordance with the invention uses a linear backing strip with a linear pile attached to one side thereof. The fibers constituting the pile may be yarn, monofilament, or combinations of such material. Areas are left on the backing strip between the pile and opposite edges of the backing strip. The backing strip has lineal strings of thermoplastic material extending continuously along the backing strip. The strings which cross over each other at a multiplicity of intersections where the strings are bonded to each other. The pile is flexible and the backing strip is both strong and tear-resistant due to the lineal array of strings which extend continuously along the backing strip. Bonding may leave a textured surface which further enhances flexibility and may also enhance the ultrasonic bonding of the backing strip and pile and of a plurality of weatherstrips to a carrier of material, compatible (e.g., ultrasonically weldable) with the material of the backing strips which preferably is similar to the material of the backing strips, or to each other, to provide dust plug assemblies.

In order to fabricate these assemblies, a plurality of weatherstrips are fed, together with the carrier, between an ultrasonic horn and an anvil wheel which opposes the horn. The edges of the backing strips of adjacent weatherstrips are adjacent to each other. Such edgewise-adjacent relationship may also be provided by the areas of the adjacent weatherstrips being in overlapping relationship. Such overlapping relationship brings the piles closer to each other so as to increase the density of the pile in the lateral direction, widthwise of the dust plug assembly. When the areas are in overlapping relationship, the carrier may not be needed to assemble the weatherstrips together. The ultrasonic horn may have an end with teeth which rake apart the piles of the adjacent weatherstrips and contact the areas, while the carrier and the backing strips are compressed against each other between the ultrasonic horn and the rotary anvil wheel. Alternatively, the piles may be separated by ridges around the anvil wheel which contact the areas while the horn is engaged against the exposed face of the carrier, or the exposed sides of the overlapping areas. Welding is carried out when the horn is energized, and the areas of the backings are welded together and to the carrier. There are therefore, a plurality of weldment strips rather than a heavy and extensive weldment which enhances the flexibility of the dust plug. For attachment of the dust plug to a frame member or other support, a double-sided pressure sensitive adhesive may be adhered on one side thereof to the exposed face of the overlapping areas or to the carrier. Release covering on the opposite side of the adhesive may be removed upon installation of the dust plug.

The foregoing and other features and advantages of the invention, as well as presently preferred embodiments thereof, will become more apparent from a reading of the following description in connection with the accompanying drawings in which:

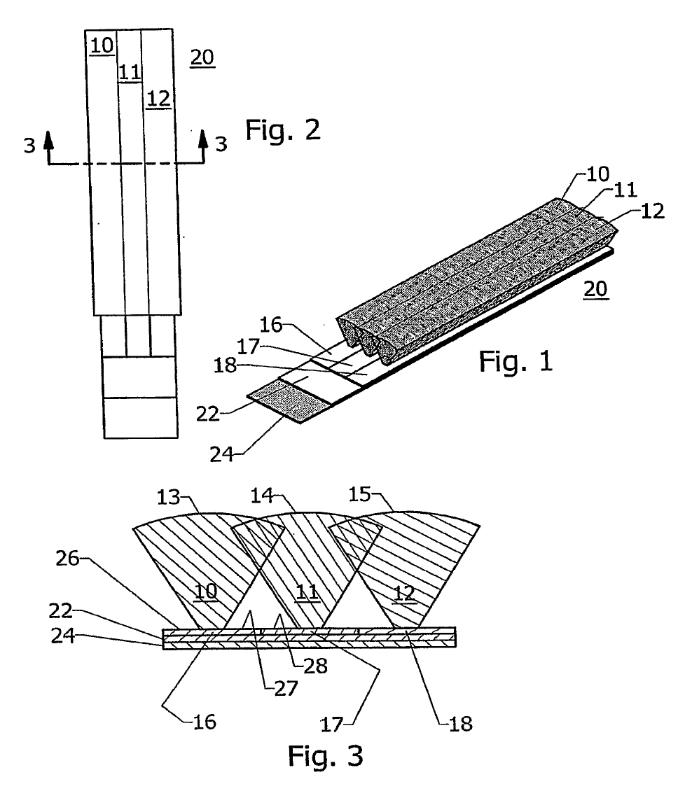

FIG. 1 is a perspective view diagrammatically illustrating weatherstrips and a dust plug assembly of such weatherstrips, in accordance with the invention;

FIG. 1A is a plan view of a magnified fragment of an example of the material of the backing strips described above;

FIG. 2 is a plan view of the dust plug assembly shown in FIG. 1;

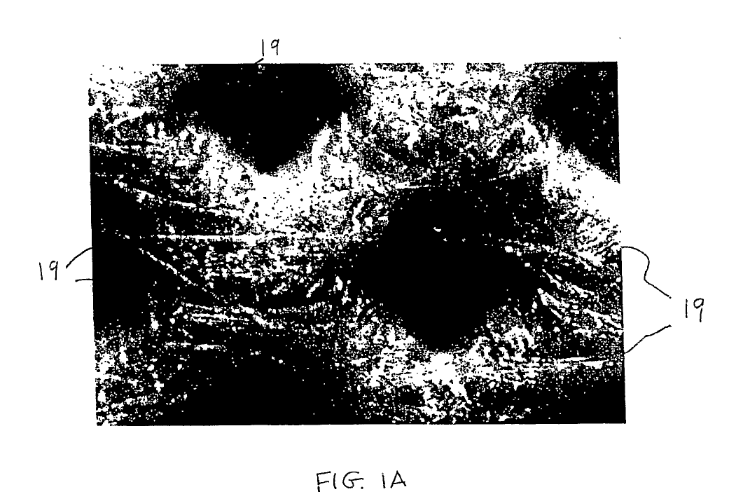

FIG. 3 is a sectional view along the line 3-3 of FIG. 2;

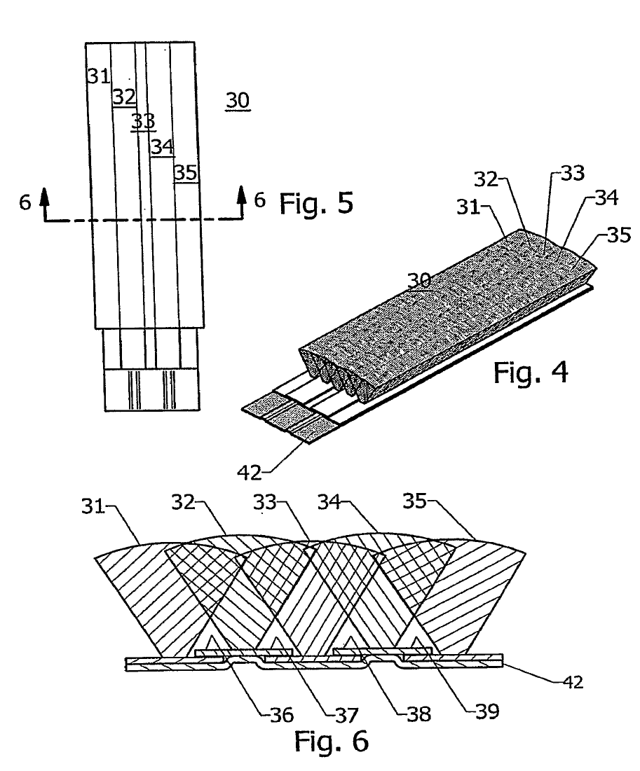

FIG. 4 is a view similar to FIG. 1 of a dust plug assembly in accordance with another embodiment of the invention;

FIG. 5 is a plan view of the dust plug assembly shown in FIG. 4;

FIG. 6 is a sectional view along the line 6-6 in FIG. 5 of the dust plug shown in FIGS. 4 and 5;

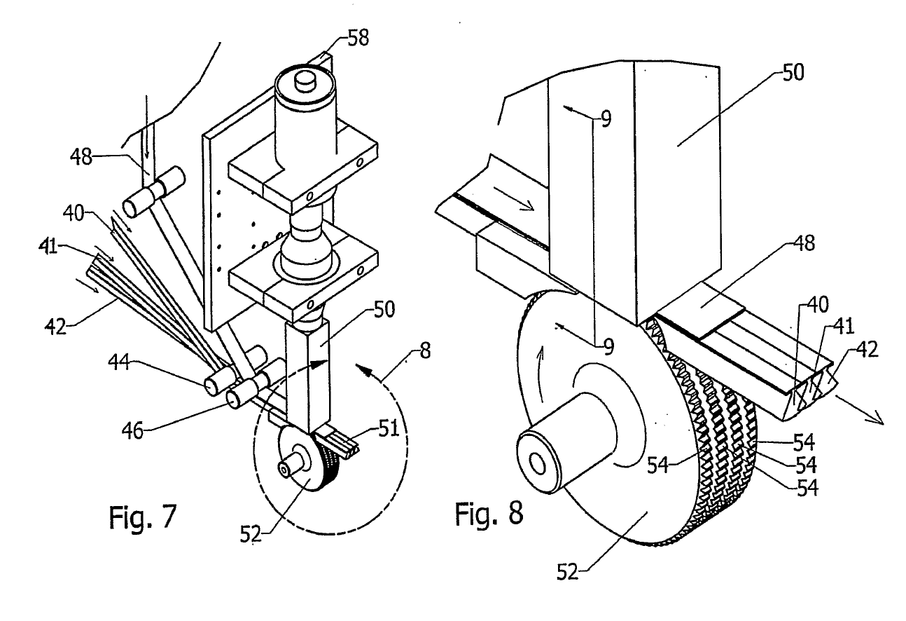

FIG. 7 is a diagrammatic perspective view of apparatus for making dust plugs such as shown in the previous figures;

FIG. 8 is an enlarged fragmentary perspective view taken along the circular dashed line 8 in FIG. 7;

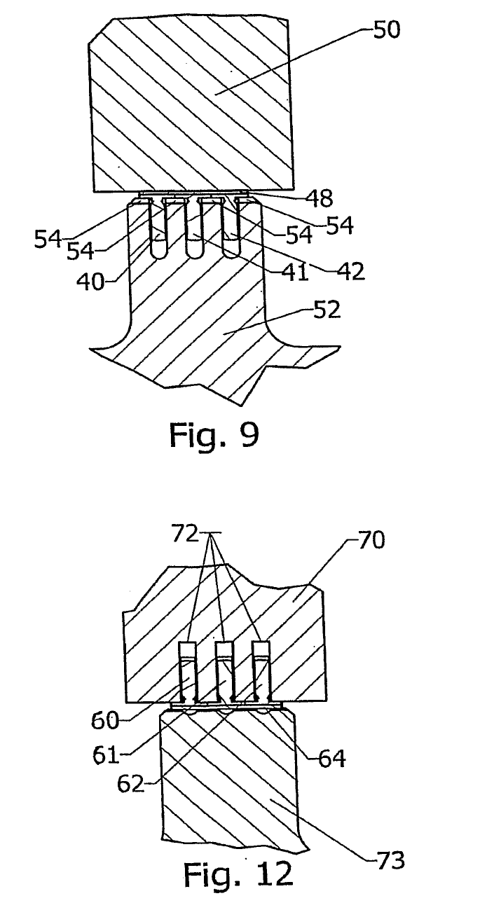

FIG. 9 is a fragmentary sectional view along the line 9-9 in FIG. 8;

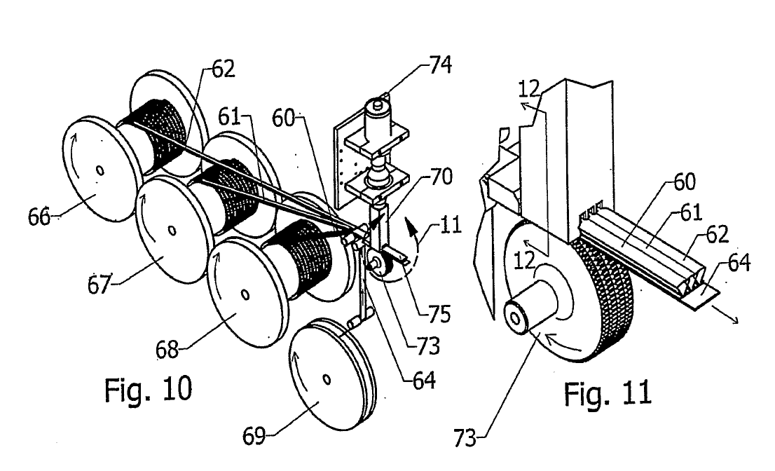

FIG. 10 is a diagrammatic perspective view illustrating another embodiment of the apparatus for making the dust plugs shown in FIGS. 1-6;

FIG. 11 is an enlarged view of the region shown by the circular dashed line 11 in FIG. 10; and

FIG. 12 is a fragmentary sectional view along the line 12-12 in FIG. 11.

Referring to FIGS. 1, 2 and 3 of the drawings, there is shown three weatherstrips 10, 11 and 12 having piles 13, 14 and 15 attached to backing strips 16, 17 and 18, respectively. These weatherstrips 10-12 may be made as described in the above-identified Horton or Johnson patents. A fin having shingled layers as shown in the above-referenced Horton Patent No. 4,302,494 may be provided if desired. Such shingling of the fin is preferred in order to provide flexibility in finned weatherstrips. The material of the backing strips 16-18 is a non-woven material made of individual strings (or fibers) of thermoplastic material. The strings run continuously along the linear length of the backing and are criss-crossed randomly so as to provide a plurality of intersections where the strings cross. These intersections are thermally bonded, preferably with an embossing tool so as to provide an embossed textured finish. This embossment may be in a diamond pattern. The material is preferably nylon, specifically Trilobal nylon. The strings may be round. A suitable thermally bonded nylon material used for such backing strips made of these strings may be procured from Cerex Advanced Fabric, Inc., 610 Chemstrand Road, Pensacola, Fla. 32533, USA. Other thermoplastic strings (or fibers) may be used in the material, such as polypropylene. The nylon material which was found to be suitable for the weatherstripping and elsewhere in the dust plugs provided in accordance with the invention, had a weight of 4.0 oz. per square yard, and the material had a nominal thickness between its opposite faces of 19.4 mils. A magnified fragment of the front surface of an example of the material is shown in FIG. 1A. Some of the strings 19, are shown in the view. The view shows that the exemplary nylon non-woven material has a deep diamond embossing with a pitch distance of 0.090 inch and 0.045 inch stagger row to row. The material is flat on the back surface and is textured on the front surface (shown). The magnification of the view of FIG. 1A is approximately 60×.

The dust plug 20 is an assembly of the three weatherstrips 10, 11 and 12 on a substrate or carrier 22. This carrier may be of material similar to that used for the backing strips 16, 17 and 18. The carrier 22 is compatible insofar as weldability to the backing strips is concerned, with the backing strip material. Preferably, the carrier is of material sufficiently wide to accommodate the plurality of weatherstrips 10, 11 and 12 which is used. The assembly is completed using double-sided adhesive 24. One side is attached to the exposed surface of the carrier 22, the other side may have a covering of release material which is removed upon installation of the dust plug 20.

The piles 13, 14 and 15 of the weatherstrips 10, 11 and 12 are attached to one side, referred to herein for convenience as the upper side of the backing strips, leaving areas 27 and 28 between the piles 13 and 14 and the opposite edges of the backing strip 16. The other backing strips 17 and 18 have similar areas between their opposite edges and their piles 14 and 15. The weatherstrips are assembled on the carrier 22 in edgewise-adjacent relationship. The edges of the area 27 and area 28 of the backing strips 16 and 17, respectively, are in contact. Adjacent areas of the weatherstrips 11 and 12 are also in contact. This contacting relationship leaves the upper portions of the piles 13, 14, and 15 in contacting and overlapping relationship, as best shown for example in FIG. 3, so as to provide a continuous dust plug seal.

The areas 27 and 28 of the weatherstrip 10 and similar areas of the other weatherstrips 11 and 12 are ultrasonically welded to the carrier 22 preferably using the apparatus shown in FIGS. 7-9, or FIGS. 10-12.

The dust plug assembly 20 is shown having only three weatherstrips 10, 11 and 12. It will be appreciated that more weatherstrips may be employed when wider dust plugs are needed. It will be understood that the invention includes single weatherstrips (any of weatherstrips 10, 11 and 12) or assemblies of two weatherstrips.

Referring to FIGS. 4, 5 and 6, there is shown a dust plug 30 having five weatherstrips 31, 32, 33, 34, and 35. Each of these weatherstrips is similar to the weatherstrips 10, 11 and 12 shown in FIGS. 1-3. These weatherstrips 31-35 have backing strips which may be attached to a carrier. However, because of the overlapping edgewise relationship of the areas 36, 37, 38 and 39 which may be welded together using the apparatus shown in FIGS. 7-9 or 10-12, but without a carrier 22. Once welded together, a double-sided adhesive tape 42 may be applied similar to the tape 24 described in connection with FIGS. 1, 2 and 3.

In the dust plug 30, the weatherstrips 31-35 are in edgewise adjacent relationship but have their areas overlapping so that they can be welded together thereby optionally avoiding the need for a carrier or substrate. In addition, more weatherstrips may be retained in the same area as is the case with the dust plug 20 shown in FIGS. 1-3 thereby providing a higher density of the yarn or fibers of the piles of the weatherstrips 31-35.

Referring to FIGS. 7, 8 and 9, there is shown the case where the plurality of weatherstrips 40, 41 and 42 are fed via guides 44 and 46 together with the carrier 48 between an ultrasonic horn assembly 50 and a rotary, either freely rotatable or driven anvil wheel 52. The wheel 52 has toothed rings or ridges 54 thereon which are laterally separated by a distance laterally corresponding to the lateral separation of the areas of the backing strips of the weatherstrips 40, 41 and 42. The wheel 52 is on the side of the assembly from which the piles of the weatherstrips 40, 41 and 42 extend. The ridges 54 separate the piles of the weatherstrips and extend all the way to the areas of the backing strips. The horn 50 opposes the carrier 48 and compresses the carrier against the backing strips. Compression force may be applied by a pneumatic cylinder (not shown) attached to the bracket 58 which supports the ultrasonic horn assembly 50.

The assembled product 51 may be driven in by the anvil wheel 52 when driven, or with a driver take up reel or a pressure roller capstan mechanism (not shown) downstream of the horn 50 and anvil wheel 52.

When ultrasonic energy is applied, the areas of the backing strips and the opposing contacting areas of the carrier 48 are welded to each other thereby providing linear weldments along the assembly. The double-sided adhesive tape may be applied in a separate operation and the assembly cut to selected widths and lengths which customers desire for the dust plugs they are purchasing.

In FIGS. 10, 11 and 12, the weatherstrips 60, 61, 62, and the carrier 64 are payed off reels 66, 67, 68 and 69, respectively. The weatherstrips 60-62 and the carrier 64 are fed together between an ultrasonic horn 70 and a freely rotating or driven anvil wheel 73. The lower end of the ultrasonic head 70 has a series of notches 72 forming rakes which extend through the piles to contact at the end thereof the adjacent or overlapping areas of the weatherstrip 60, 61 and 62. The anvil wheel 73 bears against the carrier 48 or the back of the backing strips in the event that a carrier is not used. Pressure may be applied to the ultrasonic head 70 as with a pneumatic cylinder (not shown) connected to the bracket 74 supporting the ultrasonic head 70. Again, the linear areas are welded so as to assemble the weatherstrips 60, 61 and 62 into a dust plug. A double-sided adhesive tape may be applied so as to facilitate installation of the dust plug. The dust plug may be cut to length and width as desired.

When anvil wheel 73 is freely rotatable and not driven, a driver take up reel for the product 75 or a pressure roller and driver capstan may be used as mentioned in connection with FIGS. 7-9.

From the foregoing description, it will be apparent that there has been provided an improved multidirectional flexible weatherstrip and dust plugs made therewith. Variations and modifications in the herein described weatherstrip and dust plug will undoubtedly become apparent to those skilled in the art. Accordingly, the foregoing description should be taken as illustrative and not in a limiting sense.

1. Linear weatherstripping with multidirectional flexibility comprising a linear backing strip, a linear pile attached to one side of said backing strip leaving areas between said pile and opposite edges of said backing strip, said backing strip having lineal strings of thermoplastic material extending continuously along the backing strip in which said strings cross over each other at a multiplicity of intersections where said strings are bonded to each other to provide said pile and said backing strip with multidirectional flexibility.

2. The weatherstripping of claim 1 further comprising a linear carrier of material similar to said backing strip, said carrier being wider than said backing strip, and a plurality of linear weatherstrippings like said linear weatherstripping and including said linear weatherstripping as one of said plurality, said plurality of linear weatherstrippings being in edgewise adjacent relationship and being attached to said carrier on one side thereof in said areas thereof, said plurality of weatherstrippings and said carrier being of selected length as to provide a dust plug.

3. The weatherstripping which provides the dust plug of claim 2 wherein said areas are in overlapping relationship to minimize the spacing between said piles of said plurality of weatherstrippings.

4. The weatherstripping which provides the dust plug of claim 3 wherein said overlapping areas thereof define a continuous surface for attachment to a frame or other member directly or via an adhesive tape attached to said continuous area.

5. The weatherstripping which provides the dust plug of claim 2 further comprising an adhesive connector on the side of said carrier opposite to the side thereof on which said piles are attached.

6. The dust plug or weatherstripping of claim 4 wherein said strings are of nylon.

7. The dust plug or weatherstripping of claim 4 wherein said strings are of Trilobal nylon.

8. The dust plug or weatherstripping of claim 4 wherein said strings are of polypropylene.

9. The dust plug or weatherstripping of claim 4 wherein said backing strip has a textured surface embossed thereon, said surface being provided where said intersections of said strings are bonded.

10. The dust plug or weatherstripping of claim 4 wherein an ultrasonic weldment attaches said pile to said backing strip of each of said plurality of weatherstrippings, and said carrier to said backing strip of each of said plurality of weatherstrippings.

11. A method of making linear weatherstripping useful as dust plugs comprising the steps of:
feeding a plurality of weatherstrips having backings of continuous linear strings of thermoplastic fiber which are in criss-crossed relationship to provide intersections which are bonded to each other and having linear piles which are attached to said backings on one side thereof leaving areas of said backings between said piles and opposite edges of said strips;
feeding a carrier wider than said backing strips and of the material substantially the same as said weatherstrips, between an ultrasonic welding horn and a rotatable wheel providing an anvil, with said weatherstrips in edgewise adjacent relationship and said weatherstrips overlaying said carrier on a side thereof opposite from the side to which said piles are attached and from which said piles extend;
disposing said horn against said carrier and said piles against said anvil wheel;
separating said piles apart with ridges on the periphery of said wheel which ridges are laterally spaced corresponding to said areas of said backings; and
applying ultrasonic energy to said horn to ultrasonically weld said backings to said carrier in said areas.

12. The method according to claim 11 wherein said feeding strip is carried out to bring said areas of said adjacent backing strips into overlapping relationship thereby minimizing the width of said areas presented to said ridges on said wheel.

13. A method of making linear weatherstripping useful as dust plugs comprising the steps of:
feeding a plurality of weatherstrips having backings of continuous linear strings of thermoplastic fiber which are in criss-crossed relationship to provide intersections which are bonded to each other and having linear piles which are attached to said backings on one side thereof leaving areas of said backings between said piles and opposite edges of said strips;
feeding a carrier wider than said backing strips and of the material substantially the same as said weatherstrips, between an ultrasonic horn and a rotatable wheel providing an anvil with said weatherstrips in edgewise adjacent relationship and said weatherstrips overlaying said carrier on a side thereof opposite from the side to which said piles are attached and from which said piles extend;
separating said piles by extending said horn through said piles into contact with said areas, with the aid of rakes providing an end of said horn;
urging said opposite sides of said backings and said carrier, into contacting relationship; and
applying ultrasonic energy to said horn to weld said backing and said carrier in said areas.

14. The method of claim 13 wherein said feeding step is carried out to bring said areas of said adjacent backing strips into overlapping relationship thereby minimizing the width of said areas presented by said areas to said rakes of said horn.

15. A method of making dust plugs comprising the steps of:
feeding a plurality of weatherstrips having backings of linear strings of thermoplastic fiber which are in criss-crossed relationship to provide intersections which are bonded to each other and having linear piles which are attached to said backings on one side thereof leaving areas of said backings between said piles and opposite edges of said strips;
advancing said weatherstrips with said overlapping areas of said backing between an ultrasonic horn and a rotatable wheel which provides an anvil against which said overlapping areas bear; and
applying ultrasonic energy via said horn to said overlapping areas to weld said areas together.

16. Apparatus comprising separate means which carry out each step of the method of claim 15.
